(19) United States
(12) Patent Application Publication
(10) Pub. No.: US 2006/0019022 A1
(43) Pub. Date: Jan. 26, 2006

(54) Surface-modified hard caramels with improved storage life

(76) Inventors: Jorg Bernard, Albsheim (DE); Jorg Kowalczyk, Eisenberg/Steinborn (DE); Markwart Kunz, Worms (DE)

Correspondence Address: OSTROLENK FABER GERB & SOFFEN, 1180 AVENUE OF THE AMERICAS, NEW YORK, NY, 100368403, US

(21) Appl. No.: 10/536,336

(22) PCT Filed: Dec. 2, 2003
(86) PCT No.: PCT/EP03/13561

§ 371 Date: Aug. 3, 2005

(30) Foreign Application Priority Data
Dec. 4, 2002 (DE) 102 58 146.0

(51) Int. Cl. A23G 3/00

(52) U.S. Cl. 426/660

(57) ABSTRACT

The invention relates to hard caramels whose surface is modified by surface active agents and/or hydrophobic substances, characterized by improved storage life. In another aspect of the invention, the hard caramel contains an acid, optionally a buffered acid.

The present invention relates to hard caramels which have a surface modified by surface-active agents and which have improved storage stability.

Sugar-containing caramels absorb water in a humid atmosphere, leading after prolonged storage usually to products which are sticky and soft or liquefying. The sugar-free hard caramels known in the art are also capable of improvement in relation to their storability. These disadvantages derive from the nature and composition of the sugar substitute or mixtures thereof used to manufacture the hard caramels.

German Offenlegungsschrift No. 27 29 896 discloses a process for manufacturing hard caramels from xylitol, where powdered xylitol is added to the molten xylitol at a temperature below the melting point of xylitol. However, since xylitol crystallizes very easily, the resulting anhydrous products are polycrystalline and do not have the necessary glass-like structure. The products may therefore contain up to 10% by weight sorbitol. However, sorbitol has a number of disadvantages. For example, it is very hygroscopic. Sorbitol-containing products therefore become moist and sticky on prolonged storage.

U.S. Pat. No. 4,971,798 discloses hard caramels comprising hydrogenated isomaltulose. Hydrogenated isomaltulose, which is also referred to as isomalt, is an approximately equimolar mixture of 6-O-α-D-glucopyranosyl-D-sorbitol (1,6-GPS) and the stereoisomer 1-O-α-D-glucopyranosyl-D-mannitol (1,1-GPM). Particularly because of the low solubility of 1,1-GPM, the hydrogenated isomaltulose used in said hard caramels is prone to recrystallize, so that the hard caramels become cloudy.

EP 0 886 474 B1 discloses the use of 1-O-α-D-glucopyranosyl-D-sorbitol (1,1-GPS) and of a 1,1-GPS-containing sweetener mixture composed of 1,6-GPS, 1,1-GPM and 1,1-GPS in caramels. 1,1-GPS reduces the tendency of 1,1-GPM to crystallize. These caramels are, because of their 1,1-GPS content, nonhygroscopic and have improved storability.

EP 0 847 242 B1 describes hard caramels manufactured with use of a sweetener mixture composed of 1,1-GPM and 1,6-GPS, which has more than 57% by weight 1,1-GPM. These hard caramels form on the surface a microcrystalline boundary layer which evidently contributes to reducing the H₂O uptake and stickiness of the hard caramels and thus increasing their storage life. The 1,1-GPM-enriched hard caramels additionally show increased thermal stability.

Numerous processes for improving the storage stability of hard caramels by coating are also known in the art.

Thus, DE 195 32 396 C2 for example describes coated products comprising a core and a coating, where the coating comprises at least one layer of a 1,6-GPS-enriched mixture of 1,6-GPS and 1,1-GPM in a ratio of 57 wt %:43 wt % to 99 wt %:1 wt % and of a 1,1-GPM-enriched mixture of 1,6-GPS and 1,1-GPM in a ratio of 1 wt %:99 wt % to 42 wt %:57 wt %. Products coated in this way are therefore enveloped by sequences of layers differing in composition. A longer shelf life of the coated products is achieved in particular when one or more 1,1-GPM-enriched layers are disposed between core and outer layer. Because the solubility of the 1,1-GPM-enriched layers is lower than that of conventional hydrogenated isomaltulose, on the one hand diffusion of moisture from the core to the surface of the coated product is prevented, and on the other hand less moisture penetrates in a humid atmosphere from the surroundings into the core, so that the shelf life is improved also under these conditions.

However, it has emerged overall that hard caramels disclosed to date in the art are capable of improvement in terms of their storage life. The technical problem on which the present invention is based is thus to provide hard caramels with improved storage life.

The present invention solves the problem on which it is based by providing a hard caramel with a surface modified by at least one surface-active agent. The present invention also solves the problem on which it is based by providing a hard caramel which contains an edible acid, in particular a buffered acid.

The inventive hard caramels with modified surface are notable, just like the inventive hard caramels comprising an edible acid, in particular a buffered edible acid, by absorbing significantly less water from the surroundings during storage than conventional hard caramels having no surface modified by means of surface-active agents, or comprising no edible acid. The inventive hard caramels are therefore, because of the considerably reduced water uptake, substantially more stable on storage than conventional hard caramels. A further advantage of the inventive modification of the hard caramel surface is that both sugar-containing and sugar-free hard caramels can be treated in this way in order to increase their storage stability. Sugar-containing hard caramels with a surface modified by surface-active agents, and sugar-containing hard caramels comprising an edible acid are therefore, in contrast to conventional sugar-containing hard caramels, not sticky and do not liquefy. In the case of sugar-free hard caramels with a surface modified by surface-active agents and in the case of sugar-free hard caramels comprising an edible acid, in contrast to conventional sugar-free hard caramels the recrystallization of the sugar substitutes is considerably reduced. The inventive hard caramels thus have an advantageous visual appearance even after prolonged storage. The inventive modification of the hard caramel surface advantageously does not lead to an impairment of the appearance nor, or only to a very small extent, to an impairment of the taste of the hard caramels. A further advantage of the inventive modification of the surface of hard caramels is that it is simple and extremely cost-effective to carry out. Thus, finished hard caramels manufactured by conventional processes can simply be immersed in a solution comprising surface-active agents, or in the surface-active agents themselves. Finished hard caramels after manufacture can also be sprayed or coated with a solution comprising surface-active agents, or with the surface-active agents themselves.

The invention thus provides for improving the storage life of hard caramels by modifying the surface of the hard caramel with use of at least one surface-active agent in such a way that the hard caramel absorbs less water from the surroundings.

The invention therefore relates to a hard caramel whose surface is modified by means of at least one surface-active agent.

In connection with the present invention, a “hard caramel” means a confectionary product which is manufactured by boiling down a solution of sugar types and/or sugar substitutes, in particular sugar alcohols, until the dry matter content is not less than 95%. Because of the lower residual water content caused by the boiling down, hard caramels have a hard, often glass-like consistency. Hard caramels additionally comprise odorizing and flavoring, coloring and consistency-affecting materials. Hard caramels can be manufactured batchwise, continuously or by melt extrusion. Hard caramels may be in pressed or molded form with or without fillings, for example composed of maltitol syrup. Hard caramels, in contrast to soft caramels, contain no fat.

“Surface-active agents” or “interface-active agents” mean in connection with the present invention in particular those organic substances which become highly concentrated from their solution at interfaces, for example water/oil, and thus reduce the interfacial tension, in the case of liquid/gaseous systems the surface tension.

The surface-active agents used in the inventive modification of the hard caramel surface are not release waxes or release agents, for example lecithin or carnauba wax/beeswax combinations, which are normally employed for manufacturing hard caramels. Release waxes or release agents are intended in particular to prevent the liquid hard caramel composition adhering to the conveyor belts employed to transport the liquid hard caramel composition before this composition is pressed or molded to hard caramels. Owing to the manufacturing process, minimal amounts of the release wax/release agent are incorporated into the hard caramel by the pressing and molding. Thus, whereas release waxes or release agents are employed during the hard caramel manufacturing process, in particular before the pressing or molding of the hard caramels, the surface-active agents used according to the invention for modifying the hard caramel surface are applied according to the invention to the finished hard caramels after the pressing and molding of the hard caramels, that is after the hard caramel manufacturing process.

In a preferred embodiment of the invention, the surface-active agent is not a release wax or release agent, in particular not lecithin or not a carnauba wax/beeswax mixture, and is located exclusively on the surface of the hard caramel and not in the caramel.

A particularly preferred embodiment of the invention relates to a hard caramel with a surface modified by a surface-active agent, where the surface-active agent is an emulsifier.

In connection with the present invention, an “emulsifier” means a substance which stabilizes an emulsion, that is a disperse system of two or more mutually immiscible liquids, over a prolonged period by suppressing or delaying separation of the phases to give the thermodynamically stable final state. Emulsifiers reduce the interfacial tension between the phases and stabilize the emulsion by interfacial films and by forming steric or electrical barriers, thus preventing coalescence of the emulsified particles. Emulsifiers must therefore have interface- or surface-active properties so that the interfacial tension between the immiscible phases is reduced. Emulsifiers must additionally be able to charge particles in such a way that they repel each other or form a stable protective layer around the particles. Emulsifiers are usually in the form of oily or waxy, frequently also powdered materials. A structural characteristic of emulsifiers is the amphiphilic molecular structure. The molecule of an emulsifier has at least one group with affinity for substances of high polarity (polar or hydrophilic group) and at least one group with affinity for nonpolar substances (apolar or lipophilic group). The presence together of hydrophilic and lipophilic groups in the molecule makes it possible for the emulsifier to enter into interactions both with hydrophilic and with lipophilic phases.

The invention provides in a preferred embodiment for the emulsifier used for the surface modification of hard caramels to be a monoglyceride of high molecular weight fatty acids, a diglyceride of high molecular weight fatty acids, an ester prepared by use of monoglycerides and/or diglycerides of high molecular weight fatty acids, or a mixture thereof. Monoglycerides mean in particular partial esters of glycerol with high molecular weight fatty acids. The monoglycerides employed according to the invention for the surface modification of hard caramels may be commercially available monoglycerides consisting of mixtures of mono- and diesters, that is diglycerides, with small proportions of triglycerides.

In a particularly preferred embodiment of the invention, the monoglyceride is Dimodan PV®. In a further preferred embodiment of the invention, the ester prepared by use of monoglycerides and/or diglycerides is a citric ester, in particular a citric ester of a mixture of mono- and diglycerides. The citric ester of mono-diglycerides is preferably Sugin 472 C/IKV®.

The emulsifier may also be according to the invention a sorbitan ester. Sorbitan esters are mono-, di- and triesters of sorbitans. Sorbitans or monoanhydrosorbitols are 4-hydric alcohols produced by removing one mole of water from sorbitol. The sorbitan ester preferably employed for the surface modification of hard caramels is sorbitan tristearate, in particular Sorbester 65®, or polyoxyethylene sorbitan monostearate, in particular Tween 60®.

A particularly preferred embodiment of the invention relates to a hard caramel with a surface modified by a surface-active agent, where the surface-active agent is a hydrophobic substance.

In connection with the present invention, a “hydrophobic substance” means a compound characterized in that it does not penetrate into water and remain therein. Hydrophobic compounds are therefore among the interface-active substances.

In a preferred embodiment of the invention, the hydrophobic substance by which the surface of hard caramels is modified includes at least one glyceride of fatty acids, preferably a mixture of a plurality of glycerides of saturated fatty acids.

The glyceride mixture is preferably the Spezialöl 2685®. The invention also provides the possibility for the glyceride mixture to be a mixture of triglycerides of saturated fatty acids, where the saturated fatty acids have in particular 8 to 10 C atoms. The triglyceride mixture employed for the surface modification of hard caramels is preferably Miglyol 854®.

The triglyceride mixture used according to the invention may additionally comprise beeswax. The beeswax-containing triglyceride mixture is particularly preferably according to the invention Miglyol 855®.

The invention of course provides for the inventive hard caramels to have a surface modified by a plurality of surface-active agents. Treatment of the hard caramel surface with a plurality of surface-active agents has extremely advantageous synergistic effects in relation to improved storage stability.

The invention likewise provides for the surface-active agent used to modify the hard caramel surface, especially when it has an oily consistency or is an oil, additionally to comprise flavors so that when the hard caramels are consumed initially not just oil but the flavorings present in the flavors are sucked off in the mouth. In a preferred embodiment, the surface-active agent may comprise for example an aromatic essence. In a further preferred embodiment of the invention, the surface-active agent is itself an aromatic essence.

A particularly preferred embodiment of the invention relates to a hard caramel with a surface modified by a surface-active agent, where the surface-modified hard caramel comprises an acid, in particular an edible acid. In connection with the present invention, an “acid” or “edible acid” means an organic acid which influences, in particular reduces, especially owing to its buffering action, the recrystallization of sugars and/or sugar substitutes in a hard caramel, and in this way contributes to reducing the water uptake by hard caramels and thus improving the storage stability of the hard caramels. The invention thus provides for the storage stability of the inventive hard caramels which have a surface modified by surface-active agents to be further increased by the hard caramels being manufactured with use of an edible acid.

The edible acids present in the inventive hard caramels are preferably malic acid, citric acid or lactic acid. If lactic acid is used, the invention provides for this to be present in hard caramels preferably in an amount of 1% by weight based on the total mass of the hard caramel.

A particularly preferred embodiment of the invention provides for the inventive hard caramel to comprise a buffered acid. In connection with the present invention, a “buffered acid” means an aqueous solution of electrolytes which changes its pH only negligibly or not at all after addition of hydrogen ions or hydroxide ions. Acids can be buffered with all salts of weak acids and strong bases. The effect of these buffer substances used to buffer the acid derives from the trapping reaction of the hydrogen ions or hydroxide ions.

The buffered acid used for manufacturing the inventive hard caramels is preferably buffered with a neutral salt of the same acid. When buffered lactic acid is used, the lactic acid is buffered with a neutral salt of lactic acid, preferably calcium lactate or sodium lactate, as lactic acid buffer. The inventive hard caramel particularly preferably comprises from 0.1% by weight to 2% by weight of buffered lactic acid based on the total mass of the hard caramel.

In a preferred embodiment of the invention, the inventive hard caramel with a surface modified by at least one surface-active agent is a sugar-containing hard caramel.

In connection with the present invention, “sugars” or “sugar types” mean products such as sucrose, purified crystalline sucrose, for example in the form of refined sugar, raffinate, refined white sugar, white sugar or semi-white sugar, aqueous solutions of sucrose, for example in the form of sugar solution, aqueous solutions of sucrose which has been partially inverted by hydrolysis, for example invert sugar syrup or invert sugar solution, glucose syrup, dried glucose syrup, dextrose containing water of crystallization or dextrose without water of crystallization. The inventive sugar-containing hard caramel is thus a hard caramel which comprises sucrose, invert sugar solution, invert sugar syrup, dextrose and/or glucose syrup as sweetener.

In a further particularly preferred embodiment of the invention, the inventive hard caramel with a surface modified by at least one surface-active agent is a sugar-free hard caramel.

In connection with the present invention, a “sugar-free hard caramel” means a hard caramel which contains no sugar types as sweetener, that is neither sucrose, invert sugar solution, invert sugar syrup, dextrose nor glucose syrup, but sugar substitutes. The term “sugar substitutes” includes all substances apart from the aforementioned sugar types which can be used for sweetening food products. The term “sugar substitutes” includes besides the intense sweeteners, for example aspartame, acesulfame K, cyclamate and saccharin, substances such as hydrogenated mono- and disaccharide sugar alcohols, for example lactitol, xylitol, sorbitol, mannitol, maltitol, isomalt, 1,6-GPS, 1,1-GPS and 1,1-GPM, and fructose, leucrose, sorbose, isomaltulose, condensed palatinose, hydrogenated condensed palatinose and fructooligosaccharides.

In a preferred embodiment of the invention, the sugar-free hard caramel is a caramel having a maximum content of the aforementioned sugar types of 0.5% by weight based on the dry weight.

The inventive sugar-free hard caramels preferably comprise maltitol syrup, mannitol, xylitol, sorbitol, 1,6-GPS (6-O-α-D-glucopyranosyl-D-sorbitol), 1,1-GPS (1-O-α-D-glucopyranosyl-D-sorbitol), 1,1-GPM (1-O-α-D-glucopyranosyl-D-mannitol) or a mixture thereof as sweetener.

A preferably used mixture of 1,6-GPS and 1,1-GPM is isomalt, with 1,6-GPS and 1,1-GPM being present in almost equimolar amounts. It is also possible according to the invention for the inventive sugar-free hard caramels to comprise 1,6-GPS-enriched mixtures of 1,6-GPS and 1,1-GPM and 1,1-GPM-enriched mixtures of 1,6-GPS and 1,1-GPM as sweetener, especially the mixtures disclosed in DE 195 32 396 C2, the disclosure content of this publication relating to the description and provision of the 1,6-GPS-enriched and 1,1-GPM-enriched sweetener mixtures being included in its entirety in the disclosure content of the present teaching. It is also possible according to the invention to employ 1,1-GPS-containing mixtures of 1,6-GPS and 1,1-GPM as sweetener, especially the mixtures disclosed in EP 0 625 578 B1, the disclosure content of this publication relating to the description and provision of the 1,1-GPS-, 1,6-GPS- and 1,1-GPM-containing sweetener mixtures being included in its entirety in the disclosure content of the present teaching.

The inventive sugar-free hard caramels with a surface modified by at least one surface-active agent may comprise besides the aforementioned sugar substitutes in addition one or more intense sweeteners, especially cyclamate, saccharin, aspartame, glycyrrhizin, neohesperidin dihydrochalcone, thaumatin, monellin, acesulfame, alitame and/or succralose.

The inventive sugar-containing or sugar-free hard caramels with a modified surface may moreover additionally comprise colorants, odorants, flavorings, binders and/or fillers. Suitable colorants are both synthetic and natural colorants. Suitable synthetic colorants are, for example, erythrosine, indigo camine, tartrazine or titanium dioxide. Suitable natural colorants are, for example, carotenoids such as □-carotene, riboflavins, chlorophyll, anthocyans, betanin and the like. Examples of fillers which can be used are polydextrose or inulin. Examples of binders which can be employed are compounds from the group of alginates, gelatin or cellulose. Flavorings include the substances normally used, for example essential oils, synthetic flavors or mixtures thereof, for example oils from plants or fruits such as citrus oil, fruit essences, peppermint oil, clove oil, aniseed, etc.

The invention also provides for the inventive hard caramels with a surface modified by surface-active agents, especially the inventive sugar-free hard caramels, to comprise medicinally active constituents.

The present invention also solves the problem underlying it by providing a hard caramel which comprises at least one edible acid, in particular at least one buffered acid.

The invention thus provides for reducing the uptake of water by the hard caramels during storage by manufacturing the hard caramels with use of at least one acid, in particular of an edible acid. The inventive hard caramels manufactured with use of an edible acid are therefore advantageously notable for an improved storage life.

The edible acid present in the inventive hard caramels is preferably malic acid, citric acid or lactic acid. If lactic acid is used, the invention provides for this to be present in hard caramels preferably in an amount of 1% by weight based on the total mass of the hard caramel.

A particularly preferred embodiment of the invention provides for the inventive hard caramel to comprise a buffered acid.

Owing to its buffering effect, the buffered acid present in the inventive hard caramel can influence, in particular reduce, the recrystallization of sugars and/or sugar substitutes in the hard caramel, so that the water uptake of hard caramels is reduced and thus the storage stability of the hard caramels is improved.

The buffered edible acid used for manufacturing the hard caramels is preferably buffered with a neutral salt of the same acid. When buffered lactic acid is used, the lactic acid is therefore preferably buffered with a neutral salt of lactic acid, in particular calcium lactate or sodium lactate, as lactic acid buffer. The inventive hard caramel particularly preferably comprises from 0.1% by weight to 2% by weight of buffered lactic acid based on the total mass of the hard caramel.

The inventive hard caramels comprising an acid or a buffered acid may be either sugar-containing or sugar-free hard caramels. The inventive sugar-containing or sugar-free hard caramels may moreover additionally comprise colorants, odorants, flavorings, binders and/or fillers.

The present invention likewise relates to the use of a surface-active agent for modifying the surface of a hard caramel, it being possible for the hard caramel to be either a sugar-containing or a sugar-free hard caramel. The invention therefore also relates to the use of a surface-active agent for improving the storage life of a sugar-containing or of a sugar-free hard caramel.

The surface-active agent used for modifying the hard caramel surface or for improving the storage life of a hard caramel may be according to the invention an emulsifier or a hydrophobic substance.

The invention provides for the emulsifier used to be a monoglyceride of high molecular weight fatty acids, a diglyceride of high molecular weight fatty acids, an ester prepared by use of such a monoglyceride or diglyceride, or a mixture thereof. A monoglyceride which is preferably used according to the invention is Dimodan PV®. An esterification product of monoglycerides and/or diglycerides which is preferably employed according to the invention is a citric ester, in particular Sugin 472 C/IKV®. It is also possible according to the invention to employ as emulsifier a sorbitan ester such as sorbitan tristearate, for example Sorbester 65®, or polyoxyethylene sorbitan monostearate, for example Tween 60®.

The invention provides for the hydrophobic substance used to include at least one glyceride of saturated fatty acids or a mixture of a plurality of glycerides of saturated fatty acids. In a preferred embodiment of the invention, the mixture of a plurality of glycerides of saturated fatty acids is Spezialöl 2685®. In a further preferred embodiment of the invention, the mixture of a plurality of glycerides includes a mixture of triglycerides of saturated fatty acids, in particular fatty acids having 8 to 10 carbon atoms. A triglyceride mixture which is preferably used according to the invention is Miglyol 854®. It is possible according to the invention for the used mixture of triglycerides of saturated fatty acids additionally to comprise beeswax. A beeswax-containing triglyceride mixture preferably used according to the invention is Miglyol 855®.

The present invention likewise relates to the use of an edible acid, in particular of a buffered edible acid, for improving the storage life of a sugar-containing or of a sugar-free hard caramel.

The edible acid used for improving the storage life of hard caramels is preferably malic acid, citric acid or lactic acid. A buffered edible acid is particularly advantageously employed for improving the storage life of hard caramels, the edible acid being buffered with a neutral salt of the same acid. When buffered lactic acid is used, the lactic acid is therefore preferably buffered with a neutral salt of lactic acid, in particular calcium lactate or sodium lactate, as lactic acid buffer.

The present invention also relates to a method for increasing the storage stability of sugar-containing or sugar-free hard caramels, where the surface of already manufactured hard caramels is modified by application of at least one surface-active agent.

The invention thus provides for improving the storage life of hard caramels by applying at least one surface-active agent to the hard caramel surface after manufacture of the hard caramels. The hard caramels themselves can be manufactured by conventional processes. For example, the hard caramels can be manufactured by cooking a sweetener or sweetener mixture with water at a temperature of from 140° C. to 200° C. in a candy cooker for a sufficiently long time, the cooking taking place where appropriate under vacuum. After the composition has cooled to temperatures of about 100° C. to 120° C., flavors and edible acids and, where appropriate, further sweeteners can be added. The composition is then molded or pressed to candies and cooled further. The hard caramel manufacture can, however, also take place in a continuous cooking system. Alternatively, the hard caramels can also be manufactured by the melt extrusion process, but in this case no water is added.

After manufacture of the hard caramels, the finished hard caramels are surface-modified according to the invention. A preferred embodiment of the inventive process provides for the finished hard caramels to be immersed in a solution or emulsion which comprises one or more surface-active agents, or into the surface-active agents themselves, and then dried. A further embodiment of the inventive process provides for the finished hard caramels to be sprayed with a solution or emulsion which comprises one or more surface-active agents, or with the surface-active agents themselves, and subsequently dried. Yet a further embodiment of the inventive process provides for the surface-active agent(s) to be applied by use of coating processes to the surface of the finished hard caramels. The surface-active agent(s) can for example be applied to the hard caramels by using soft coating processes. A “soft coating” means according to the invention the application of surface-active agents which are dissolved or present in an emulsion or liquid to hard caramels which are in motion, a powder of one or more surface-active agents being sprinkled on after each application. The surface-active agent(s) can also be applied to the hard caramels by using hard coating processes. “Hard coating” means according to the invention likewise the application of surface-active agents which are dissolved or present in an emulsion or liquid to hard caramels which are in motion, but in contrast to the soft coating process without sprinkling on a powder of surface-active agents.

It is possible according to the invention for the solution or emulsion of the surface-active agent(s), or the surface-active agent(s) if liquid, additionally to comprise flavorings, for example flavors such as aromatic essences.

The invention also provides on use of coating processes for applying surface-active agents to hard caramels for sugar or sugar substitutes also to be applied to the hard caramel cores at the same time or beforehand or thereafter. Thus, it is possible for example to use for coating the hard caramels a solution which, besides the surface-active agent(s), also comprises dissolved sugar types or sugar substitutes. The powder of a surface-active agent which is sprinkled onto the hard caramel after application of a solution during soft coating may also comprise for example a saccharide powder. On the other hand, the surface-active agent-containing solution or the surface-active agent-containing powder can be applied to a hard caramel which has already been coated with a solution of a sugar or sugar substitute and/or with a saccharide powder. It is also possible according to the invention for a hard caramel which has already been coated for example with a surface-active agent-containing solution and/or a surface-active agent-containing powder subsequently to be coated with a solution of a sugar or sugar substitute and/or with a saccharide powder.

The invention is explained in more detail by means of the following figures and examples.

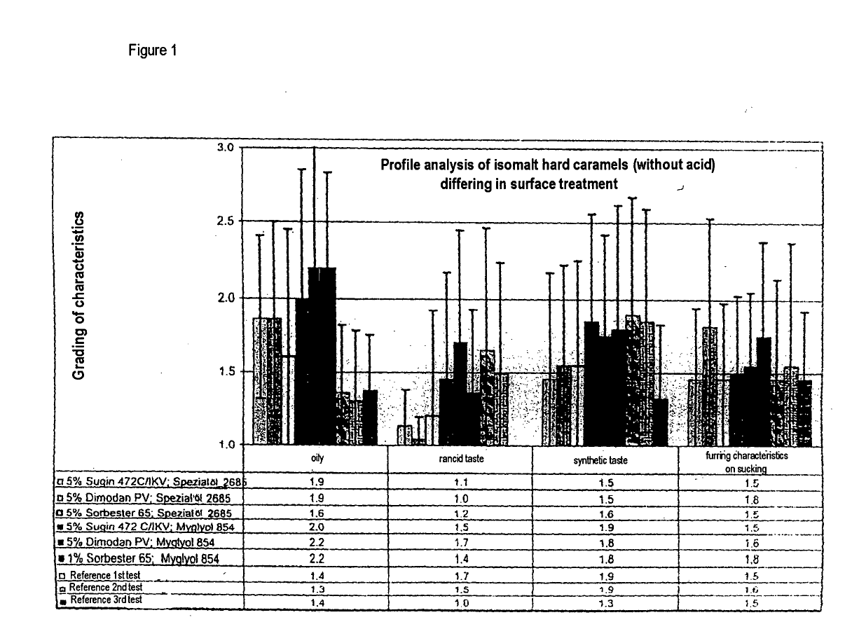

FIG. 1 shows in graphical form the results of an analysis of acid-free isomalt hard caramels with different surface treatment with regard to taste and sucking characteristics.

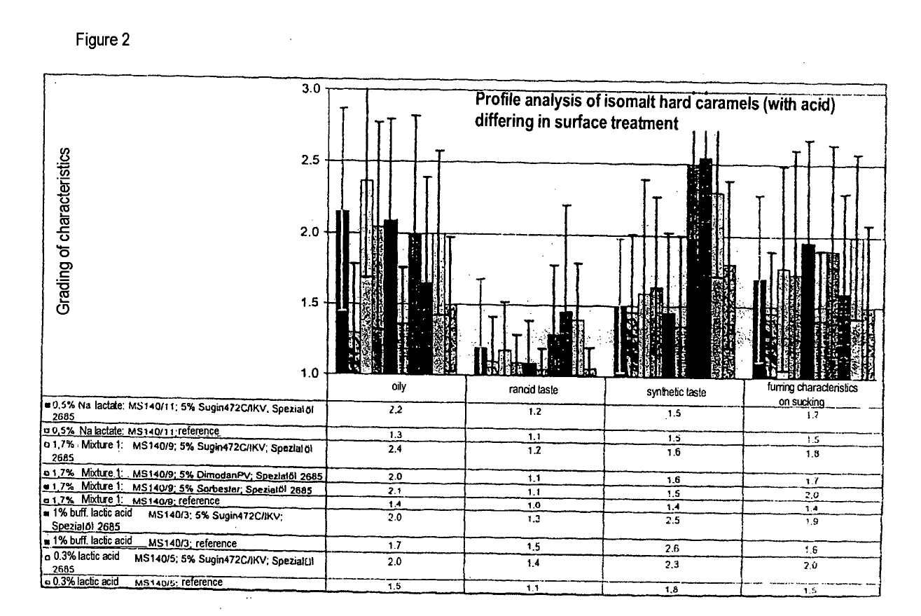

FIG. 2 shows in graphical form the results of an analysis of edible acid-containing isomalt hard caramels with different surface treatment with regard to taste and sucking characteristics.

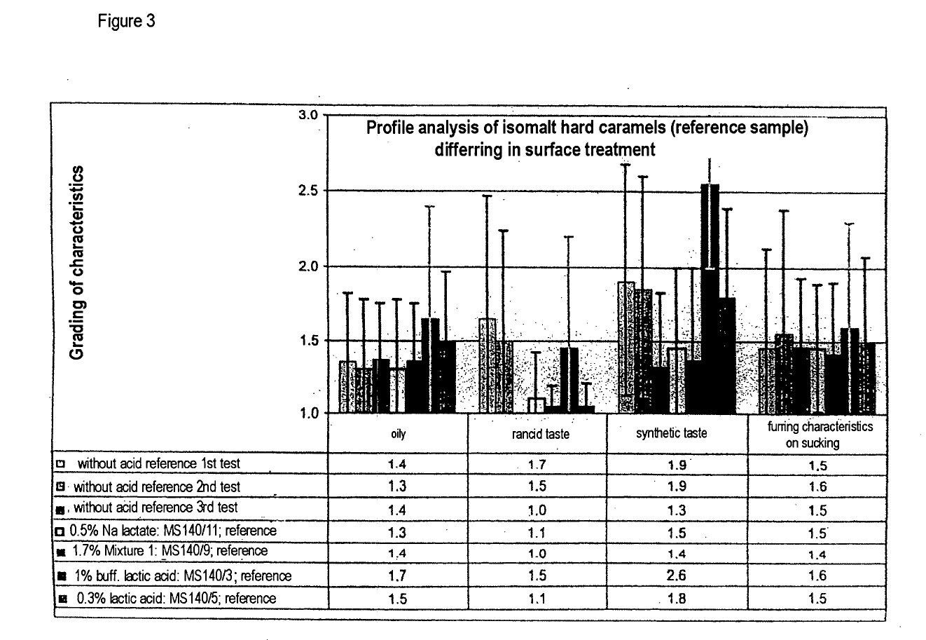

FIG. 3 shows in graphical form the results of an analysis of isomalt hard caramels (reference sample) with different surface treatment with regard to taste and sucking characteristics.

### EXAMPLE 1

Improving the Storage Life of Sugar-Containing Hard Caramels

Manufacture of Sugar-Containing Hard Caramels

Molded hard caramels were manufactured from sugar glucose syrup (100/100) in accordance with conventional processes. Manufacture took place by boiling a batch in a batch cooker and subsequently molding the composition. Table 1 shows the composition of the sugar-containing hard caramels.

TABLE 1
Composition of the sugar-containing hard caramels

| | |
|---|---|
| Water content | 4.5 wt % |
| Sucrose | 46.8 wt % |
| Fructose | 0.8 wt % |
| Glucose | 9.5 wt % |
| Maltose | 7.7 wt % |
| Maltotriose | 6.2 wt % |
| Oligosaccarides | 24.5 wt % |

Surface Modification

The surface of the sugar-containing hard caramels was then modified with use of a mixture of an emulsifier and of an oil.

The molded hard caramels were divided into four portions and modified by immersion in an emulsifier-oil solution.

Table 2 shows the nature of the surface modification of the four portions of the sample.

TABLE 2
Surface modification of sugar-containing hard
caramels

| | Surface | | |
|---|---|---|---|
| Sample | modification | Water uptake | Remarks |
| 1 | none | 4.3 wt % | HC* liquefied |
| 2 | 5% Sugin 472 C/IKV + 95% | 1.3 wt % | HC* not |
| | Spezialöl | | liquefied |
| | 2685 | | |
| 3 | 5% Sorbester 65 + 95% | 2.2 wt % | HC* starting |
| | Spezialöl 2685 | | to liquefy |
| 4 | 5% Dimodan PV + 95% | 1.6 wt % | HC* not |
| | Spezialöl 2685 | | liquefied |

HC* = hard caramels

Determination of the Storage Life

The storage life of the hard caramels was investigated in a stress test (storage at 25° C./70% r.h. (relative humidity) for three days). The water uptake during the storage test was determined by gravimetry. In addition, the hard caramels were photographed. Typically, the sugar/glucose syrup hard caramels do not recrystallize but liquefy on storage in a moist atmosphere.

Conclusion

The surface modification with an emulsifier/oil mixture brings about a distinct reduction in the water uptake of sugar-containing hard caramels. This prevents liquefaction of the caramels during storage. The storage life of sugar-containing hard caramels is thus distinctly improved by the surface modification.

### EXAMPLE 2

Effect of Surface-Active Substances on the Storage Life of Isomalt Hard Caramels

Experiment 1

Pure isomalt glasses were molded. The surface of the isomalt hard caramels was modified by immersing the hard caramels in an emulsifier solution or an emulsifier-fat mixture. The glasses prepared in this way were stored in the open at 25° C./80% r.h. for three days. The water uptake in the stress test was determined and the stored samples were photographed. Glasses without surface modification were stored as reference. The water content of all the samples amounted to 1.5% by weight.

Table 3 shows the emulsifiers used for surface modification of isomalt hard caramels.

TABLE 3

| Name | Substance class | Manufacturer | E number |
|---|---|---|---|
| Sugin 476 M | PGPR | Degussa | E 476 |
| Sugin 472 | Citric ester of mono- | Degussa | E 472c |
| C/IKV | diglycerides | | |
| Sorbester 65 | Sorbitan tristearate | Degussa | E 492 |
| Dimodan PV | Mono-diglycerides | Vanisco | E 471 |
| Tween 60 | Polyoxyethylene | Merck | |
| | sorbitan monostearate | Schuchard | |
| Tween 80 | Polyoxyethylene | Merck | |
| | sorbitan monooleate | Schuchard | |

Table 4 shows the fats and oils used for surface modification of isomalt hard caramels.

TABLE 4

| Name | Fat type | Manufacturer |
|---|---|---|
| Witarix 250 | Coconut fat | Condea |
| Witocan HS | Coconut and palm kernel oil | Condea |
| Miglyol 812S | Triglyceride of saturated | SASOL |
| | vegetable fatty acids (C8/C10) | |
| Miglyol 854 | Triglyceride of saturated | SASOL |
| | vegetable fatty acids (C8/C10), | |
| | beeswax | |
| Miglyol 855 | Triglyceride of saturated | SASOL |
| | vegetable fatty acids (C8/C10), | |
| | beeswax | |
| Miglyol 864 | Triglyceride of saturated | SASOL |
| | vegetable fatty acids (C8/C10), | |
| | beeswax, carnauba wax | |
| Miglyol 866 | Triglyceride of saturated | SASOL |
| | vegetable fatty acids (C8/C10), | |
| | beeswax, carnauba wax | |
| Miglyol 870 | Triglyceride of saturated | SASOL |
| | vegetable fatty acids (C8/C10), | |
| | carnauba wax | |
| Spezialöl | Glycerides of saturated fatty | SASOL |
| 2685 | acids | |

Table 5 shows the water uptake of the isomalt glasses treated with an emulsifier or an emulsifier-fat/oil mixture in the stress test.

TABLE 5

| | Emulsifier | | | Water uptake |
|---|---|---|---|---|
| Experiment | | Amount/ | Fat/oil | in stress |
| MS 136- | Type | wt % | type | test/wt % |
| 1 | Sugin 476 M | 100 | — | 1.7 |
| 2 | Tween 60 | 100 | — | 1.7 |
| 3 | Sugin 472 | 5 | Spezialöl | 1.1 |
| | C/IKV | | 2685 | |
| 4 | Sorbester | 5 | Spezialöl | 0.9 |
| | 65 | | 2685 | |
| 5 | Dimodan PV | 5 | Spezialöl | 0.8 |
| | | | 2685 | |
| Reference | — | — | — | 2.5 |

The amount of the emulsifier refers to the content in the emulsifier-fat immersion solution in g/100 g of mixture.

Experiment 2

In a second experiment, further combinations of emulsifiers and fat/oils were tested. Table 6 shows the emulsifiers and fats/oils used and their effect on the water uptake of hard caramels in the stress test.

TABLE 6

| | Emulsifier | | | Water uptake |
|---|---|---|---|---|
| Experiment | | Amount/ | | in stress |
| MS 139- | Type | wt % | Fat/oil type | test/wt % |
| 1 | Tween 60 | 5 | Witocan HS | 1.3 |
| 2 | Tween 60 | 5 | Miglyol 854 | 0.6 |
| 3 | Tween 60 | 5 | Miglyol 855 | 1.1 |
| 4 | Tween 60 | 5 | Miglyol 870 | 1.1 |
| 5 | Sugin 472 | 5 | Witocan HS | 0.3 |
| | C/IKV | | | |
| 6 | Sugin 472 | 5 | Miglyol 854 | 1.0 |
| | C/IKV | | | |
| 7 | Sugin 472 | 5 | Miglyol 855 | 0.8 |
| | C/IKV | | | |
| 8 | Sugin 472 | 5 | Miglyol 870 | 0.9 |
| | C/IKV | | | |
| 9 | Sorbester 65 | 5 | Witocan HS | 0.5 |
| 10 | Sorbester 65 | 5 | Miglyol 854 | 1.1 |
| 11 | Sorbester 65 | 5 | Miglyol 855 | 0.7 |
| 12 | Sorbester 65 | 5 | Miglyol 870 | 0.6 |
| 13 | Dimodan PV | 5 | Witocan HS | 0.3 |
| 14 | Dimodan PV | 5 | Miglyol 854 | 0.9 |
| 15 | Dimodan PV | 5 | Miglyol 855 | 0.6 |
| 16 | Dimodan PV | 5 | Miglyol 870 | 1.0 |
| 17 | Sorbester 65 | 10 | Spezialöl | 0.8 |
| | | | 2685 | |
| 18 | Sorbester 65 | 1 | Miglyol 854 | 0.3 |
| 19 | Sorbester 65 | 10 | Miglyol 854 | 0.9 |
| 20 | Sorbester 65 | 1 | Miglyol 870 | 0.9 |
| 21 | Sorbester 65 | 10 | Miglyol 870 | 0.9 |

The isomalt hard caramels treated in this way exhibit recrystallization. In the pairs of samples 139-18/139-19 and 139-20/139-21, the mixing ratio of the particular Sorbester 65/fat combination was varied.

Sample 139-18 has a clear surface without recrystallization after the stress test. According to the criteria of “water uptake” and “appearance”, this sample has the greatest storage stability after the stress test.

Conclusion:

The storage stability of the isomalt hard caramels is distinctly increased on use of combinations of the emulsifiers Sugin 472 C/IKV, Sorbester 65 and Dimodan 65 with the fats/oils Miglyol 854, Miglyol 855 and Spezialöl 2685, with clear glasses being obtained after the stress test.

### EXAMPLE 3

Effect of Surface-Active Substances on the Storage Stability of Acid-Containing Isomalt Hard Caramels

Manufacture of Acid-Containing Isomalt Hard Caramels

Isomalt glasses to which lactic acid or a buffered lactic acid was added after boiling were molded. The isomalt glasses obtained in this way were then surface-modified by immersion in a hydrophobic substance mixture. The glasses prepared in this way were stored in the open at 25° C./80% r.h. for three days. The water uptake in the stress test was then determined, and the stored samples were photographed. Glasses without surface modification were stored as reference.

Table 7 shows the lactic acid products and products containing buffered lactic acid which were used to manufacture the isomalt glasses.

TABLE 7

| | Purac FCC | Puracal | Purasal | Purac BF |
|---|---|---|---|---|
| Name | 80 | PP/FCC | S/SP 60 | S/30 |
| chem. | L(+)-lactic | Calcium L- | Sodium | L-buffered |
| identity | acid | lactate | L-lactate | lactic acid |
| | | pentahydrate | | (Na salt) |
| Add. info. | solution | powder | solution | solution |
| DM salt/ | — | 74 | 60 | 20.4 |
| wt % | | | | |
| DM acid/ | 79.7 | — | — | 59.6 |
| wt % | | | | |
| Water/ | 20.3 | 26 (loss on | 40 | 20 |
| wt % | | drying) | | |
| pH | <2 | 6.9 | 6-7.5 | 3.1 |
| | | (10 wt %) | (10 wt %) | (10 wt %) |
| E number | E 270 | E 327 | E 325 | E 270, E 325 |

The lactic acid Purac FCC 80 and the buffered lactic acid Purac BF S/30 were employed directly for manufacturing acid-containing isomalt hard caramels. In addition, further lactic acid buffers (“mixture”) were prepared and employed for manufacturing acid-containing isomalt hard caramels. Table 8 shows the prepared lactic acid buffers.

TABLE 8
Composition of prepared lactic acid buffers

| | Acid | | Salt | | |
|---|---|---|---|---|---|
| Short | | Amount/ | | Amount/ | pH |
| name | Type | wt % | Type | wt % | (10 wt %) |
| Mixture 1 | Purac | 1.5 | Purasal | 98.5 | 3.3 |
| | FCC 80 | | S/SP60 | | |
| Mixture 2 | Purac | 1.9 | Puracal | 98.1 | 5.5 |
| | FCC 80 | | PP/FCC | | |
| Mixture 3 | Purac | 1.7 | Puracal | 48.3 | 5.5 |
| | FCC 80 | | PP/FCC | | |
| | | | Purasal | 50 | |
| | | | S/SP60 | | |

It is possible by using the lactic acid products, lactate and lactic acid buffers to manufacture hard caramels whose pH is in the acidic to neutral range.

The concentration of the added acid, of the added lactate and of the buffered lactic acid has an effect on the recrystallization of the hard caramels. Thus, in the manufacture of the hard caramels, the concentration of these additions was also varied, besides the nature of the additions.

Table 9 shows the hard caramels manufactured with use of lactic acid and/or lactic acid buffer, and the water content thereof before storage and their water uptake during the stress test.

TABLE 9

| | Addition of acid/ | | Water content | Water uptake |
|---|---|---|---|---|
| | lactate/mixture | | (before | in stress |
| Experiment | | Amount/ | storage)/ | test/ |
| MS140/ | Type | wt % | wt % | wt % |
| 2 | Purac BF | 0.3 | 1.3 | 1.2 |
| | S/30 | | | |
| 3 | Purac BF | 1 | 1.5 | 0.7 |
| | S/30 | | | |
| 4 | Purac BF | 1.9 | 1.5 | 0.7 |
| | S/30 | | | |
| 5 | Purac FCC | 0.3 | 1.3 | 7.1 |
| | 80 | | | |
| 6 | Purac FCC | 1 | 1.2 | 1.1 |
| | 80 | | | |
| 7 | Purac FCC | 1.9 | 1.3 | 2.7 |
| | 80 | | | |
| 8 | Mixture 1 | 0.5 | 1.2 | 0.6 |
| 9 | Mixture 1 | 1.7 | 1.6 | 0.8 |
| 10 | Mixture 1 | 3.1 | 2.4 | not |
| | | | | investigated |
| 11 | Purasal | 0.5 | 1.4 | 4.2 |
| | S/SP 60 | | | |
| 12 | Puracal | 0.4 | 1.3 | 0.7 |
| | PP/FCC | | | |
| 13 | Mixture 2 | 1.35 | 1.6 | 0.9 |
| 14 | Mixture 3 | 1.5 | 1.5 | 1.5 |
| MS136/A | Reference, | — | 1.5 | 2.5 |
| | no addition | | | |

The recrystallization corresponds to the water Compared with the reference, samples 2-4, 6, 8-9 and 12-14 show considerably reduced recrystallization. Of the samples comprising pure lactic acid, in particular the caramel with 1% lactic acid shows a reduced recrystallization. Addition of pure Na lactate increases the recrystallization, whereas use of pure Ca lactate leads to a considerably reduced recrystallization. On use of lactic acid buffer too, a considerably greater inhibition of recrystallization is brought about by use of Ca lactate than with Na lactate.

Surface Modification

The isomalt hard caramels manufactured with use of lactic acid and/or lactic acid buffers were subsequently surface-modified with use of surface-active agents, in particular emulsifiers and fats/oils. Table 10 shows the water uptake of the surface-modified acid-containing isomalt hard caramels as a function of the emulsifiers and fats/oils used.

The amount of emulsifier in the Spezialöl 2685 immersion solution is always 5 g/100 g.

TABLE 10

| | | Water uptake in |
|---|---|---|
| Hard caramel | Emulsifier type | stress test/wt % |
| MS140/2 | Sugin 472 C/IKV | 0.8 |
| | Dimodan PV | 0.8 |
| | Sorbester 65 | 0.6 |
| MS140/3 | Sugin 472 C/IKV | 0.4 |
| | Dimodan PV | 0.4 |
| | Sorbester 65 | 0.4 |
| MS140/4 | Sugin 472 C/IKV | 0.4 |
| | Dimodan PV | 0.4 |
| | Sorbester 65 | 0.3 |
| MS140/5 | Sugin 472 C/IKV | 2.0 |
| | Dimodan PV | 2.3 |
| | Sorbester 65 | 3.3 |
| MS140/6 | Sugin 472 C/IKV | 0.7 |
| | Dimodan PV | 0.7 |
| | Sorbester 65 | 0.6 |
| MS140/7 | Sugin 472 C/IKV | 1.0 |
| | Dimodan PV | 1.0 |
| | Sorbester 65 | 0.7 |
| MS140/8 | Sugin 472 C/IKV | 0.4 |
| | Dimodan PV | 0.4 |
| | Sorbester 65 | 0.4 |
| MS140/9 | Sugin 472 C/IKV | 0.5 |
| | Dimodan PV | 0.5 |
| | Sorbester 65 | 0.4 |
| MS140/11 | Sugin 472 C/IKV | 0.6 |
| | Dimodan PV | 1.2 |
| | Sorbester 65 | 1.4 |
| MS140/12 | Sugin 472 C/IKV | 0.3 |
| | Dimodan PV | 0.5 |
| | Sorbester 65 | 0.4 |
| MS140/13 | Sugin 472 C/IKV | −1.6 |
| | Dimodan PV | 0.5 |
| | Sorbester 65 | 0.5 |
| MS140/14 | Sugin 472 C/IKV | 0.7 |
| | Dimodan PV | 0.7 |
| | Sorbester 65 | 0.6 |

The samples were clear after the stress test. The visually detectable recrystallization corresponds to the water uptake. The sample MS140/13 with Sugin forms an exception, losing water in the stress test but not differing visually from the samples MS140/13 with Dimodan or Sorbester. Recrystallization of all the samples is reduced compared with hard caramels without surface modification.

It was investigated in a further experiment whether the application of Tween 60 without fat to the surface of isomalt hard caramels containing no acid has an effect on recrystallization. In the stress test, the hard caramel treated in this way absorbed 1.1% by weight water. The hard caramels are smooth on the surface and show no recrystallization after the stress test.

Conclusion:

Isomalt hard caramels containing a lactic acid buffer show less crystallization in the stress test than hard caramels without acid or hard caramels containing pure lactic acid. The use of buffer systems with Ca lactate emerges as particularly advantageous, and even addition of pure Ca lactate inhibits recrystallization.

Surface modification with a mixture of oil and the emulsifiers Sugin 472 C/IKV, Dimodan PV and Sorbester 65 leads to a distinctly reduced water uptake and recrystallization of all the investigated hard caramels containing lactic acid and/or lactate.

### EXAMPLE 4

Effect of Edible Acids on the Storage Stability of Isomalt Hard Caramels

Manufacture of Isomalt Hard Caramels

A melt with a water content of about 1.8% was cooked from isomalt ST and deionized water in a batch cooker in vacuo. On use of a buffered acid, the acid was stirred as solution into the melt. This was followed by brief evacuation in order to readjust the original water content. Both molded and pressed isomalt glasses were manufactured from the melt.

The buffered acids added were buffered L-lactic acid Purac BF S/30 (80% strength solution) and buffered citric acid CITROSTABIL (75% strength solution, Jungbunzlauer).

The composition of the pressed glasses was determined by HPLC and Karl-Fischer titration. The composition of the glasses is shown in table 11.

TABLE 11

| | | | | | | | | Buffered |
|---|---|---|---|---|---|---|---|---|
| | Water/ | GPM/ | GPS/ | Mannitol/ | Sorbitol/ | Remainder/ | | acid |
| | wt % | wt % | wt % | wt % | wt %% | wt % | pH | addition |
| MS114/2 | 1.8 | 47.7 | 44.8 | 0.7 | 0.7 | 3.6 | 6.3 | — |
| MS114/4 | 1.7 | 48.2 | 45.3 | 0.3 | 0.3 | 3.8 | 3.3 | 1.9 wt % |
| | | | | | | | | lactic acid |
| MS114/6 | 1.6 | 48.7 | 45.7 | 0.2 | 0.3 | 2.1 | 3.4 | 0.3 wt % |
| | | | | | | | | lactic acid |
| MS114/8 | 1.8 | 49.6 | 43.8 | 0.5 | 0.5 | 4.3 | 2.9 | 1.3 wt % |
| | | | | | | | | citric acid |
| MS114/4 | 1.7 | 50.9 | 44.4 | 0.5 | 0.5 | 2.5 | 3.2 | 0.3 wt % |
| | | | | | | | | citric acid |

Determination of the Storage Stability

The storage stability of the manufactured glasses was investigated in a stress test (4 days, 25° C./80% r.h.) on the basis of the water uptake and the visual appearance.

Table 12 shows the water uptake as a function of the composition of the isomalt glasses.

TABLE 12

| | | Acid addition | | Water uptake |
|---|---|---|---|---|
| Name | Acid | wt % | Shaping | wt % |
| MS114/1 | none | 0 | molded | 1.79 |
| MS114/5 | buff. lactic | 0.3 | molded | 1.07 |
| | acid | | | |
| MS114/3 | buff. lactic | 1.9 | molded | 1.13 |
| | acid | | | |
| MS114/9 | buff. citric | 0.3 | molded | 1.46 |
| | acid | | | |
| MS114/7 | buff. citric | 1.3 | molded | 1.34 |
| | acid | | | |
| MS114/2 | none | 0 | pressed | 2.28 |
| MS114/6 | buff. lactic | 0.3 | pressed | 1.87 |
| | acid | | | |
| MS114/4 | buff. lactic | 1.9 | pressed | 1.72 |
| | acid | | | |

The results obtained show that the addition of buffered acids distinctly reduces the water uptake of isomalt glasses. Moreover, the effect of buffered lactic acid is considerably stronger than that of buffered citric acid. The reduced water uptake is to be found both in pressed and in molded glasses in the same way. The somewhat higher water uptake of pressed glasses is attributable to the larger surface area-volume ratio with pressed glasses compared with molded glasses.

### EXAMPLE 5

Effect of Surface-Active Substances on the Storage Stability of Acid-Containing Isomalt HC Hard Caramels

Isomalt HC glasses to which lactic acid or buffered lactic acid was added after cooking were molded. Isomalt HC is a mixture of 1,6-GPS, 1,1-GPM and 1,1-GPS, with small amounts of sorbitol, mannitol and other sugar alcohols possibly being present. The isomalt HC glasses were then modified on the surface by immersion in the hydrophobic substance mixture. The glasses prepared in this way were stored in the open at 25° C./80% r.h. for three days. The water uptake in the stress test was determined and the stored samples were photographed. Glasses without surface modification were stored as reference.

Table 13 shows the lactic acids and buffered acids used to manufacture the hard caramels.

TABLE 13

| | | | |
|---|---|---|---|
| Name | Purac FCC 80 | Puracal | Purac BF S/30 |
| | | PP/FCC | |
| Chem. identity | L(+)-lactic | Calcium | L-buffered |
| | acid | L-lactate | lactic acid |
| | | pentahydrate | (Na salt) |
| Add. info. | solution | powder | solution |
| DM salt | — | 74 | 20.4 |
| [wt %] | | | |
| DM acid | 79.7 | — | 59.6 |
| [wt %] | | | |
| Water | 20.3 | 26 (loss on | 20 |
| [wt %] | | drying) | |
| pH | <2 | 6.9 (10%) | 3.1 (10%) |
| E number | E270 | E327 | E270, E325 |

The buffered lactic acid was employed directly. In addition, a mixture of 1.9% by weight “Purac FCC 80” lactic acid and 98.1% by weight “Puracal PP/FCC” was prepared. Acid-containing hard caramels were manufactured by employing 1% by weight, based on DM, of lactic acid or 1.35% by weight, based on DM, of the prepared mixture.

Table 14 shows the water content of the manufactured hard caramels without surface modification and their water uptake in the stress test.

TABLE 14

| | | Water content | Water uptake |
|---|---|---|---|
| Experiment | Acid/mixture | (before storage) | in stress test |
| MS 160/ | addition | [wt %] | [wt %] |
| A | no addition | 1.4 | 3.14 |
| B | buffered | 1.4 | 1.38 |
| | lactic acid | | |
| C | mixture | 1.6 | 2.57 |

The recrystallization corresponded to the water uptake.

Subsequently, the manufactured acid-containing isomalt HC hard caramels were surface-modified using surface-active agents. The surface-modified acid-containing hard caramels were then investigated in the stress test for their water uptake. Table 15 shows the effect of the surface-active agents used on the water uptake of acid-containing isomalt HC hard caramels.

TABLE 15

| | | Water uptake in |
|---|---|---|
| | | stress test |
| Hard caramel | Emulsifier type | [wt %] |
| MS 160A | Sugin 472 C/IKV | 0.98 |
| | Sorbester 65 | 0.78 |
| | Dimodan PV | 0.87 |
| MS 160/B | Sugin 472 C/IKV | 0.60 |
| | Sorbester 65 | 0.64 |
| | Dimodan PV | 0.65 |
| MS 160/C | Sugin 472 C/IKV | 0.79 |
| | Sorbester 65 | 0.70 |
| | Dimodan PV | 1.10 |

The samples were clear and had a slightly oily surface before the stress test. The visually detectable recrystallization corresponded to the water uptake. The recrystallization was reduced with all samples compared with the hard caramels without surface modification.

Conclusion:

Isomalt HC hard caramels containing buffered lactic acid show less recrystallization in the stress test than isomalt HC hard caramels without acid or isomalt HC hard caramels containing the mixture of lactic acid and calcium lactate. Moreover, hard caramels manufactured with use of a mixture of lactic acid and calcium lactate likewise show less recrystallization than isomalt HC hard caramels manufactured without acid. The water uptake and recrystallization of isomalt HC hard caramels is reduced by the surface modification with the emulsifier-oil mixtures listed.

### EXAMPLE 6

Effect of Surface-Active Agents on the Storage Stability of Hard Caramels Comprising Maltitol Syrup, Isomalt, or a Maltitol Syrup-Isomalt Mixture

Experiments were initially carried out to investigate the effect of maltitol syrup (Lycasin 80/55) on the storage stability of hard caramels containing isomalt. The effect of emulsifiers and fats (oils) on the storage stability of the manufactured hard caramels was then investigated on selected samples.

Isomalt glasses with differing maltitol syrup content and isomalt glasses with a GPM/GPS ratio of 0.9 and differing maltitol syrup content were molded. The glasses were stored in the open at 25° C. (80% r.h.) for three days. The water uptake in the stress test was determined, and the stored samples were photographed.

Table 16 shows the composition of the manufactured hard caramels, their water content and their water uptake in the stress test.

TABLE 16

| | | | Water content | Water |
|---|---|---|---|---|
| | GPM/GPS | | (before | uptake in |
| Experiment | ratio | Maltitol syrup | storage) | stress test |
| MS 161/ | (wt/wt) | [wt %] of DM | [wt %] | [wt %] |
| 1 | 1.0 | 0 | 1.4 | 1.5 |
| 2 | 1.0 | 10 | 1.4 | 4.3 |
| 3 | 1.0 | 20 | 1.6 | 5.9 |
| 4 | 1.0 | 30 | 1.5 | 12.1 |
| 5 | 1.0 | 35 | 1.5 | 12.3 |
| 6 | 0.9 | 0 | 1.5 | 2.0 |
| 7 | 0.9 | 10 | 1.4 | 4.3 |
| 8 | 0.9 | 20 | 1.5 | 7.5 |
| 9 | 0.9 | 30 | 1.5 | 11.7 |
| 10 | 0.9 | 35 | 1.3 | 13.0 |

The recrystallization corresponded to the water The hard caramels with a GPM/GPS ratio of 0.9 absorbed more water than comparable hard caramels with a GPM/GPS ratio of 1.0. The hard caramels with a maltitol syrup content of 30% by weight and 35% by weight lost their original shape.

Some of the manufactured hard caramels underwent surface modification by immersion in a hydrophobic substance mixture. Table 17 shows the composition of the surface-modified hard caramels.

TABLE 17

| | |
|---|---|
| Hard caramel | Composition wt % DM |

| | | |
|---|---|---|
| MS 161/2 | GPM: 43.3 | Mannitol: _0.3 |
| | GPS: 41.3 | Maltitol: 4.5 |
| | Sorbitol: 0.75 | |
| MS 161/5 | GPM: 30.5 | Mannitol: 0.11 |
| | GPS: 29.1 | Maltitol: 15.1 |
| | Sorbitol: 1.26 | |
| MS 161/7 | GPM: 40.2 | Mannitol: 0.30 |
| | GPS: 43.2 | Maltitol: 4.3 |
| | Sorbitol: 0.79 | |
| MS 161/10 | GPM: 27.1 | Mannitol: 0.12 |
| | GPS: 29.2 | Maltitol: 14.8 |
| | Sorbitol: 1.32 | |

Table 18 shows the emulsifiers an oils employed for surface modification of the hard caramels described in table 17, and the effect thereof on the water uptake of the hard caramels in the stress test.

TABLE 18

| | | Water uptake in |
|---|---|---|
| | | stress test |
| Hard caramel | Emulsifier type | [wt %] |
| MS 161/2 | Sugin 472 C/IKV | 1.11 |
| | Dimodan PV | 2.20 |
| | Sorbester 65 | 1.84 |
| MS 161/5 | Sugin 472 C/IKV | 1.61 |
| | Dimodan PV | 4.15 |
| | Sorbester 65 | 4.02 |
| MS 161/7 | Sugin 472 C/IKV | 1.03 |
| | Dimodan PV | 1.64 |
| | Sorbester 65 | 1.47 |
| MS 161/10 | Sugin 472 C/IKV | 1.58 |
| | Dimodan PV | 2.74 |
| | Sorbester 65 | 2.57 |

The recrystallization corresponded to the water uptake. The surface-treated hard caramels absorbed less water than the caramels without surface treatment. The best effect with regard to inhibition of recrystallization was obtained with the hard caramels of the MS 161 series with a mixture of Sugin 472 and Spezialöl 2685.

### EXAMPLE 7

Profile Analysis of Isomalt Hard Caramels Whose Surface has been Treated with Emulsifier-Fat Mixtures

Isomalt hard caramels were manufactured with or without acid as described in examples 2, 3 and 4. The surface was then treated with emulsifier-fat mixtures. Table 19 shows the composition of the isomalt hard caramels and the nature of the surface modification.

TABLE 19

| | | Emulsifier | | |
|---|---|---|---|---|
| | | | Amount | Fat/oil |
| Sample | Hard caramel | Type | [wt %] | type |
| 1 | no acid | Sorbester 65 | 1 | Miglyol 854 |
| 2 | ″ | Sugin 472 C/IKV | 5 | Miglyol 854 |
| 3 | ″ | Dimodan PV | 5 | Miglyol 854 |
| 4 | ″ | Sorbester 65 | 5 | Spezialöl |
| | | | | 2685 |
| 5 | ″ | Sugin 472 C/IKV | 5 | Spezialöl |
| | | | | 2685 |
| 6 | ″ | Dimodan PV | 5 | Spezialöl |
| | | | | 2685 |
| 7 | ″ | reference | | |
| 8 | with 1.7% | Sugin 472 C/IKV | 5 | Spezialöl |
| | mixture 1; | | | 2685 |
| | MS140/9 | | | |
| 9 | with 1.7% | Dimodan PV | 5 | Spezialöl |
| | mixture 1; | | | 2685 |
| | MS140/9 | | | |
| 10 | with 1.7% | Sorbester | 5 | Spezialöl |
| | mixture 1; | | | 2685 |
| | MS140/9 | | | |
| 11 | with 1.7% | reference | | |
| | mixture 1; | | | |
| | MS140/9 | | | |
| 12 | with 0.5% Na | Sugin 472 C/IKV | 5 | Spezialöl |
| | lactate; | | | 2685 |
| | MS140/11 | | | |
| 13 | with 0.5% Na | reference | | |
| | lactate; | | | |
| | MS140/11 | | | |
| 14 | with 1% buff. | Sugin 472 C/IKV | 5 | Spezialöl |
| | lactic acid; | | | 2685 |
| | MS140/3 | | | |
| 15 | with 1% buff. | reference | | |
| | lactic acid; | | | |
| | MS140/3 | | | |
| 16 | with 0.3% | Sugin 472 C/IKV | 5 | Spezialöl |
| | lactic acid; | | | 2685 |
| | MS140/5 | | | |

| | | |
|---|---|---|
| 17 | with 0.3% | reference |
| | lactic acid; | |
| | MS140/5 | |

The surface characteristics, the taste and the sucking characteristics of the caramels were tested. This entailed carrying out a descriptive test with scale. The respective properties were graded by scoring from 1 (undetectable) to 3 (high grading). The samples were tested by a total of 10 people, with the reference hard caramel without acid being tested three times. The results are depicted in FIGS. 1, 2 and 3.

1. A hard caramel with a surface modified by at least one surface-active agent.

2. The hard caramel as claimed in claim 1, wherein the surface-active agent is an emulsifier.

3. The hard caramel as claimed in claim 2, wherein the emulsifier is selected from the group consisting of a monoglyceride of high molecular weight fatty acids, a diglyceride of high molecular weight fatty acids, an ester prepared by use of at least one of monoglycerides and diglycerides of high molecular weight fatty acids, and mixtures thereof.

4. The hard caramel as claimed in claim 3, wherein the ester prepared by use of said at least one of a monoglyceride and a diglyceride is a citric ester.

5. The hard caramel as claimed in claim 2, wherein the emulsifier is a sorbitan ester.

6. The hard caramel as claimed in claim 5, wherein the sorbitan ester is sorbitan tristearate.

7. The hard caramel as claimed in claim 5, wherein the sorbitan ester is polyoxyethylene sorbitan monostearate.

8. The hard caramel as claimed in claim 1 wherein the surface-active agent is a hydrophobic substance.

9. The hard caramel as claimed in claim 8, wherein the hydrophobic substance includes at least one glyceride of saturated fatty acids or a mixture of a plurality of glycerides of saturated fatty acids.

10. The hard caramel as claimed in claim 9, wherein the hydrophobic substance is a glyceride mixture and wherein the glyceride mixture is a mixture of triglycerides of saturated fatty acids having 8 to 10 carbon atoms.

11. The hard caramel as claimed in claim 10, wherein the triglyceride mixture additionally comprises a wax.

12. The hard caramel as claimed in claim 11, wherein the wax is beeswax.

13. The hard caramel as claimed in claim 1, wherein the hard caramel comprises an acid.

14. The hard caramel as claimed in claim 13, wherein the acid is selected from the group consisting of lactic acid, malic acid and citric acid.

15. The hard caramel as claimed in claim 14, wherein the acid is lactic acid and wherein the lactic acid is present in an amount of 1% by weight based on the total mass of the hard caramel.

16. The hard caramel as claimed in claim 13, wherein the acid is buffered.

17. The hard caramel as claimed in claim 16, wherein the buffered acid is a lactic acid buffered with calcium lactate or sodium lactate.

18. The hard caramel as claimed in claim 17, wherein the buffered lactic acid is present in an amount of from 0.1% by weight to 2% by weight based on the total mass of the hard caramel.

19. A sugar-containing hard caramel as claimed claim 1, comprising at least one sweetener selected from the group consisting of sucrose, invert sugar solution, invert sugar syrup, dextrose and glucose syrup.

20. A sugar-free hard caramel as claimed in claim 1, comprising at least one sweetener selected from the group consisting of maltitol syrup, mannitol, xylitol, sorbitol, 1,6-GPS, 1,1-GPS, 1,1-GPM and mixtures thereof.

21. The sugar-free hard caramel as claimed in claim 20, wherein the sweetener is an equimolar mixture of 1,6-GPS and 1,1-GPM.

22. The sugar-free hard caramel as claimed in claim 20, additionally comprising one or more intense sweeteners.

23. The hard caramel as claimed in claim 1, additionally comprising at least one of colorants, flavorings and fillers.

24. The hard caramel as claimed in claim 1, additionally comprising one or more medicinal active ingredients.

25. A hard caramel with reduced water uptake, comprising an edible acid.

26. The hard caramel as claimed in claim 25, wherein the acid is selected from the group consisting of lactic acid, malic acid and citric acid.

27. The hard caramel as claimed in claim 26, wherein the acid is lactic acid and wherein the lactic acid is present in an amount of 1% by weight based on the total mass of the hard caramel.

28. The hard caramel as claimed in claim 25, wherein the acid is buffered.

29. The hard caramel as claimed in claim 28, wherein the buffered acid is a lactic acid buffered with calcium lactate or sodium lactate.

30. The hard caramel as claimed in claim 29, wherein the buffered lactic acid is present in an amount of from 0.1% by weight to 2% by weight based on the total mass of the hard caramel.

31. The hard caramel as claimed in claim 25, wherein the hard caramel is a sugar-containing or a sugar-free caramel.

32. A method for modifying the surface of a sugar-containing or sugar-free hard caramel which comprises adding to said caramel a surface-active agent.

33. A method for improving the storage life of a sugar-containing or of a sugar-free hard caramel which comprises adding to said caramel a surface active agent.

34. The method as claimed in claim 32, wherein the surface-active agent is an emulsifier or a hydrophobic substance.

35. The method as claimed in claim 34, wherein the emulsifier is selected from the group consisting of a monoglyceride of high molecular weight fatty acids, a diglyceride of high molecular weight fatty acids, an ester prepared by use of at least one of monoglycerides and diglycerides of high molecular weight fatty acids, and mixtures thereof.

36. The method as claimed in claim 35, wherein the ester prepared by use of said at least one of monoglycerides and diglycerides of high molecular weight fatty acids is a citric ester.

37. The method as claimed in claim 34, wherein the surface-active agent is an emulsifier and wherein the emulsifier is a sorbitan ester selected from the group consisting of sorbitan tristearate and polyoxyethylene sorbitan monostearate.

38. The method as claimed in claim 34, wherein the surface-active agent is a hydrophobic substance and wherein the hydrophobic substance includes at least one glyceride of saturated fatty acids or a mixture of a plurality of glycerides of saturated fatty acids.

39. The method as claimed in claim 38, wherein the hydrophobic substance is a glyceride mixture and wherein the glyceride mixture is a mixture of triglycerides of saturated fatty acids having 8 to 10 carbon atoms.

40. The method as claimed in claim 39, wherein the triglyceride mixture additionally comprises beeswax.

41. A method for improving the storage life of a sugar-containing or of a sugar-free hard caramel which comprises adding to said caramel an edible acid.

42. The method as claimed in claim 41, where the edible acid is selected from the group consisting of malic acid, citric acid and lactic acid.

43. The method as claimed in claim 41, wherein the edible acid is buffered.

44. The method as claimed in claim 43, wherein the buffered edible acid is lactic acid buffered with calcium lactate or sodium lactate.

45. A process for increasing the storage stability of sugar-containing or sugar-free hard caramels, wherein the surface of finished hard caramels is modified by applying thereto at least one surface-active agent.

46. The process as claimed in claim 45, wherein the surface-active agent is applied to the hard caramel by immersing the hard caramels in a solution or emulsion comprising the surface-active agent.

47. The process as claimed in claim 45, wherein the surface-active agent is applied to the hard caramel by spraying the hard caramels with a solution or emulsion comprising the surface-active agent.

48. The process as claimed in claim 45, wherein the surface-active agent is applied to the hard caramel by coating the hard caramel with a solution or emulsion comprising the surface-active agent.
